(19) United States
(12) Patent Application Publication
(10) Pub. No.: US 2024/0319342 A1
(43) Pub. Date: Sep. 26, 2024

(54) PULSED LIDAR WITH SEMICONDUCTOR OPTICAL AMPLIFIER CONTROLLED BY A MODULATED SIGNAL

(71) Applicants: LEOSPHERE, Paris (FR); ONERA, Palaiseau (FR)

(72) Inventors: Vincent PUREUR, Saint-Cheron (FR); Marco CASALE, Paris (FR); Borislav MILEVSKY, Louveciennes (FR); Laurent LOMBARD, Paris (FR); Didier GOULAR, Guyancourt (FR)

(21) Appl. No.: 18/574,893

(22) PCT Filed: Jun. 30, 2022
(86) PCT No.: PCT/EP2022/068209

§ 371 Date: Dec. 28, 2023

(30) Foreign Application Priority Data
Jul. 1, 2021 (FR) FR2107164

(51) Int. Cl. G01S 7/484; G01S 7/481; G01S 17/58; G01S 17/95

(52) U.S. Cl. CPC G01S 7/484; G01S 7/4814; G01S 17/58; G01S 17/95

(57) ABSTRACT

A pulsed LiDAR including a master laser able to emit a master laser beam, a pulse generator arranged to generate a pump signal including at least one pulse, a peak value of which varies during the at least one pulse of the pump signal, and a semiconductor optical amplifier (SOA) arranged to amplify and modulate the master laser beam on the basis of the pump signal, with the amplified and modulated laser beam forming a measurement laser beam is disclosed.

### TECHNICAL FIELD

LIDARs, among other things, are used to observe the atmosphere and to determine atmospheric properties. The atmospheric properties determined can be, in particular, the wind speed, the concentration of particles in the atmosphere, their dimensions and/or their shape, and the temperature of the atmosphere.

The present invention relates to the modulation and amplification of pulsed optical signals used, in particular, by such LiDARs. The present invention aims, in particular, to generate pulsed signals with a high cadence, narrow spectral width and modulable frequency.

The present invention relates to pulsed LiDARs with an optical amplifier. The invention relates, more precisely, to a pulsed LiDAR with a semiconductor optical amplifier, called SOA, and an amplification method for such a LIDAR.

### STATE OF THE PRIOR ART

The patent document FR1461407, which relates to a LIDAR with a semiconductor optical amplifier, called SOA-LiDAR, is known from the state of the art. That document describes the use of an SOA arranged to ensure the function of intensity modulation of the master laser beam and the function of amplification of the master laser beam.

A drawback of the SOA-LiDARs of the state of the art is that they do not make it possible to determine the sign of the wind speed. In order to determine the sign of the wind speed, it is therefore necessary to incorporate an acousto-optical modulator (AOM) or phase quadrature optical demodulator into it so as to be able to determine the sign of the wind speed. In practice, the AOM introduces a given frequency shift over the amplified signal in relation to the signal from the local oscillator, i.e. the master laser. This frequency shift must be controlled, precise and constant. This frequency shift makes it possible to determine the sign of the wind speed during the heterodyne detection.

Another drawback of the SOA-LiDARs of the state of the art is due to the nonlinearity of the transfer function of the SOA, which has the result that the signal amplified and modulated by the SOA is not square and symmetrical. This causes a spectral spread of the amplified and modulated signal and a drop in the signal-to-noise ratio.

Another drawback of the SOA-LiDARs of the state of the art is that they introduce a drift of the frequency of the signal modulated and amplified by the SOA and a broadening of the Doppler peak measured, as well as the appearance of secondary peaks. The frequency drift can introduce a shift in the value of the wind speed measured. The broadening of the Doppler peak measured as well as the secondary peaks lower the precision and reproducibility of the measurements.

An aim of the invention is in particular:
to determine the sign of the wind speed by means of a LIDAR without AOM, and/or
to improve the signal-to-noise ratio, and therefore the availability of the LiDAR, and/or
to improve the reliability of the measurements of the atmospheric properties performed by the LiDAR, and/or
to measure the atmospheric properties more precisely.

### DESCRIPTION OF THE INVENTION

To this end, a pulsed LiDAR is proposed which comprises:
a master laser capable of emitting a master laser beam,
a pulse generator arranged to generate a pump signal comprising at least one pulse, a peak value of which varies over the course of said at least one pulse of said pump signal, and/or to keep a phase of at least one pulse of the signal amplified and modulated by the SOA constant or to vary it,
a semiconductor optical amplifier (SOA) arranged to amplify and modulate the master laser beam as a function of the pump signal, the amplified and modulated master laser beam forming a measurement laser beam.

The peak value of the at least one pulse of the pump signal can vary over all or part of the at least one pulse. The phase of the at least one pulse of the signal amplified and modulated by the SOA can be constant or can vary over all or part of the at least one pulse of the signal amplified and modulated by the SOA.

In the present application, the term “signal” used on its own can denote the pump signal and/or the pulse signal and/or the signal amplified and modulated by the SOA and/or the phase of the signal amplified and modulated by the SOA.

In the present application, the master laser beam amplified and modulated by the SOA or the measurement laser beam can be called signal amplified and modulated by the SOA.

The signal amplified and modulated by the SOA is preferably a pulsed signal.

On reading the application a person skilled in the art will directly deduce that a pulse can comprise a peak value and a rise and/or a fall.

The pulse generator can comprise:
an electrical generator arranged to produce a pulse signal,
a control unit arranged to vary the at least one pulse of the pump signal, preferably respectively the peak value, a rise and/or a fall of the at least one pulse of the pump signal, by modulating the pulse signal, preferably by modulating respectively a peak value, a rise and/or a fall of at least one pulse of the pulse signal produced by the electrical generator.

Preferably, the pump signal, still preferably the at least one pulse of the pump signal, corresponds respectively to the pulse signal modulated by the control unit, preferably to the at least one pulse of the pulse signal modulated by the control unit.

The control unit can be arranged to vary the phase of the at least one pulse of the signal amplified and modulated by the SOA by modulating the pulse signal produced by the electrical generator.

The control unit is preferably arranged to vary the peak value of one or more or each of the pulses of the pulse signal produced by the electrical generator.

The control unit can be arranged to modulate at least one pulse of the pulse signal.

The control unit is preferably arranged to modulate the peak value of at least one pulse of the pulse signal.

The control unit can be arranged to modulate at least one pulse of the pulse signal and not to modulate at least one pulse of the pulse signal, preferably to modulate the peak value of at least one pulse of the pulse signal and not to modulate the peak value of at least one pulse of the pulse signal.

In the present application, the terms “peak value” and/or “rise” and/or “fall” used on their own can denote the peak value and/or the rise and/or the fall of the pump signal and/or of the pulse signal and/or of the signal amplified and modulated by the SOA and/or of the phase of the signal amplified and modulated by the SOA.

The pulse generator is preferably arranged to vary a phase and/or a frequency of the signal amplified and modulated by the SOA by modulating the at least one pulse of the pump signal, preferably by modulating the peak value, the rise and/or the fall of the at least one pulse of the pump signal, still preferably by modulating the variation of the peak value of the at least one pulse of the pump signal.

The control unit is preferably arranged to vary a phase and/or a frequency of the signal amplified and modulated by the SOA by modulating the at least one pulse of the pulse signal, preferably by modulating the rise and/or the fall of the at least one pulse of the pulse signal, still preferably by modulating the peak value of the at least one pulse of the pulse signal.

The control unit can be arranged to vary a phase of at least one pulse of the signal amplified and modulated by the SOA, preferably by modulating the pulse signal.

The control unit can be arranged to:
keep the phase of the at least one pulse of the signal amplified and modulated by the SOA constant, or
vary the phase of the at least one pulse of the signal amplified and modulated by the SOA in an increasing manner, preferably over at least one time interval of the at least one pulse, and/or in a decreasing manner, preferably over at least one time interval of the at least one pulse of the signal amplified and modulated by the SOA.

The control unit can be arranged to vary the phase of the at least one pulse of the signal amplified and modulated by the SOA such that an average value of the phase over a time interval of the at least one pulse of the signal amplified and modulated by the SOA, preferably over a time interval of the at least one pulse of the signal amplified and modulated by the SOA over which the phase is increasing or respectively decreasing, is equal to an average value of the phase over another time interval of the at least one pulse of the signal amplified and modulated by the SOA, preferably over a time interval of the at least one pulse of the signal amplified and modulated by the SOA over which the phase is increasing or respectively decreasing.

The control unit can be arranged to vary the phase of the at least one pulse of the signal amplified and modulated by the SOA such that an average value of the phase over a time interval of the pulse of the signal amplified and modulated by the SOA, preferably over a time interval of the pulse of the signal amplified and modulated by the SOA over which the phase is increasing or respectively decreasing, is smaller than or greater than an average value of the phase over another time interval of the pulse of the signal amplified and modulated by the SOA, preferably over a time interval of the pulse over which the phase is increasing or respectively decreasing.

The control unit can be arranged to vary the phase of the at least one pulse of the signal amplified and modulated by the SOA such that a value of the phase varies by modulo 2n at least once over the course of the at least one pulse of the signal amplified and modulated by the SOA.

The control unit can preferably be arranged to vary the phase of the at least one pulse of the signal amplified and modulated by the SOA such that a value of the phase varies by modulo 2n several times, preferably periodically, over the course of the at least one pulse of the signal amplified and modulated by the SOA. The control unit can be arranged to vary the phase of the at least one pulse of the signal amplified and modulated by the SOA according to a pattern or a triangular shape.

According to a first preferred aspect of the invention, one or more, preferably each, pulse of the pump signal and/or of the pulse signal and/or of the signal amplified and modulated by the SOA and/or of the phase of the signal amplified and modulated by the SOA can comprise, preferably is constituted by, a rise of the signal, a peak signal and a fall of the signal. The rise of the signal is preferably effected from a minimum level, which can be a local minimum, of the signal up to the peak signal. The minimum level of the signal preferably corresponds to a zero value of the signal. The fall of the signal is preferably effected from the peak signal down to the minimum level of the signal, which is the one from which the rise is effected, or down to a local minimum of the signal which is different from the minimum level from which the rise is effected.

According to the first aspect, the peak signal of a pulse can correspond to the part of the signal of the pulse comprised between the end of the rise of the pulse and the start of the fall of the pulse. By way of nonlimitative example, in the case of a square pulse signal, the peak signal corresponds to the plateau, i.e. to the constant and maximum value of the signal, which is comprised between the end of the rise of the pulse and the start of the fall of the pulse.

According to the first aspect, by peak signal of a pulse may be meant the entirety of the values of the signal comprised between a value of the signal at the end of the rise of the pulse and a value of the signal at the start of the fall of the pulse.

According to a second aspect of the invention, incompatible with the first aspect of the invention, one or more, preferably each, pulse of the pump signal and/or of the pulse signal and/or of the signal amplified and modulated by the SOA and/or of the phase of the signal amplified and modulated by the SOA can comprise a rise or a fall and a peak signal. In other words, according to the invention, a pulse under consideration corresponds either to a pulse according to the first aspect or to a pulse according to the second aspect.

According to the second aspect of the invention, a pulse can comprise, preferably only comprises, still preferably is constituted by, more preferably is only constituted by:
a peak signal, or
a rise followed by a peak signal, or
a peak signal followed by a fall.

According to the second aspect of the invention, a pulse can comprise, preferably only comprises, still preferably is constituted by, more preferably is only constituted by, a rise followed by a peak signal. The rise of the signal is preferably effected from a minimum level, which can be a local minimum, of the signal up to a maximum level, which can be a local maximum, of the signal. The minimum level of the signal preferably corresponds to a zero value of the signal. The peak signal of the pulse can preferably correspond to the part of the signal of the pulse comprised between the maximum level of the signal and the minimum level of the signal, which is the one from which the rise is effected, or a local minimum of the signal which is different from the minimum level from which the rise is effected.

According to the second aspect of the invention, a pulse can comprise, preferably only comprises, still preferably is constituted by, more preferably is only constituted by, a peak signal followed by a fall. The peak signal of the pulse can preferably correspond to the part of the signal of the pulse comprised between a minimum level, which can be a local minimum, of the signal up to a maximum level, which can be a local maximum, of the signal. The minimum level of the signal preferably corresponds to a zero value of the signal. The fall of the signal is preferably effected from the maximum level of the signal down to the minimum level of the signal, which is the one from which the peak signal extends, or down to a local minimum of the signal which is different from the minimum level from which the peak signal extends.

According to the second aspect of the invention, a pulse can comprise, preferably only comprises, still preferably is constituted by, more preferably is only constituted by, a peak signal. In this case, the peak signal preferably corresponds to the signal of the pulse. In this case, the peak signal, preferably the signal of the pulse, can comprise:
a part of the signal of the pulse comprised between a minimum level of the signal, which can be a local minimum of the signal, which is preferably the level from which the peak signal extends, up to a maximum level of the signal, which can be a local maximum of the signal, and/or preferably followed or preceded by, still preferably followed by,
a part of the signal of the pulse comprised between the maximum level of the signal, which can be a local maximum of the signal, and down to the minimum level of the pump signal, which can be a local minimum of the signal, which is preferably the one from which the peak signal extends, or down to a local minimum of the pump signal which is different from the minimum level from which the peak signal extends.

According to the invention, the pump signal and/or the pulse signal and/or the signal amplified and modulated by the SOA and/or the phase of the signal amplified and modulated by the SOA comprises:
at least one pulse according to the first aspect of the invention, and/or
at least one pulse according to the second aspect of the invention.

The remainder of the disclosure relates equally to the first aspect and to its alternative, which is the second aspect of the invention.

According to the invention, the signal and/or the peak value and/or the rise and/or the fall can be defined by, or can vary according to or be modulated according to, a mathematical function and/or a periodic function.

By “signal” may be meant the entirety of the values of the signal in question.

The term “peak signal” used within the framework of the present application can relate, but does not only relate, to the peak power. In particular, the term “peak signal” used within the framework of the present application can relate, but does not only relate, to the peak power of the measurement signal.

The peak signal of a pulse can correspond to the entirety of the peak values of the pulse under consideration.

According to the invention, the signal can comprise successive pulses identical to or different from each other.

One or more, preferably each, pulse of the signal is preferably periodic.

The pulse generator is preferably an arbitrary signal generator.

The control unit is preferably arranged to vary the peak value of each pulse of the pump signal by modulating each pulse of the pulse signal. The control unit is preferably arranged to vary the peak value of each pulse of the pump signal by modulating the peak value of each pulse of the pulse signal.

By variation of the peak value of the at least one pulse of the pump signal may be meant:
a variation of at least a part, preferably the entirety, of the peak signal of the at least one pulse of the pump signal, or
the feature according to which the peak signal of the at least one pulse of the pump signal comprises at least a part which is not constant, preferably the entirety of the peak signal of the at least one pulse of the pump signal is not constant.

All or some of the features relating to the pump signal as described in the present application, by way of nonlimitative example the features associated with the pulse, can be transposed to the phase of the pulse of the signal amplified and modulated by the SOA. The phase of the pulse of the signal amplified and modulated by the SOA can preferably have the same features as that of the peak signal of the at least one pulse of the pump signal according to the invention.

The peak value of the at least one pulse of the pump signal can vary monotonically over at least one time interval of the at least one pulse of the pump signal.

The control unit can be arranged to vary the peak value of the at least one pulse of the pump signal monotonically over at least one time interval of the at least one pulse of the pump signal by modulating the at least one pulse of the pulse signal produced by the electrical generator, preferably by modulating the peak value of the at least one pulse of the pulse signal produced by the electrical generator.

The control unit can be arranged to vary all or part of the peak value of the at least one pulse of the pump signal linearly by modulating the at least one pulse of the pulse signal produced by the electrical generator.

The control unit can be arranged to vary a succession of peak values, for example a succession of segments of peak values, of the at least one pulse of the pump signal linearly by modulating the at least one pulse of the pulse signal produced by the electrical generator.

The control unit can be arranged to generate a function of peak values of at least one pulse of the pump signal by modulating the at least one pulse of the pulse signal produced by the electrical generator.

By time interval of the pulse may be meant a time interval comprised within the duration of the pulse.

The control unit can preferably be arranged to vary all or part of the peak signal of the at least one pulse of the pump signal monotonically by modulating the at least one pulse of the pulse signal produced by the electrical generator.

The control unit can preferably be arranged to vary the peak signal of a time interval of a given pulse of the pump signal, by modulating the at least one pulse of the pulse signal produced by the electrical generator, independently of the peak signal of another time interval of the given pulse of the pump signal.

The peak value of the at least one pulse of the pump signal can vary monotonically over the whole duration of the at least one pulse of the pump signal.

The control unit can be arranged to vary the peak value of the at least one pulse of the pump signal monotonically over the whole duration of the at least one pulse of the pump signal by modulating the at least one pulse of the pulse signal produced by the electrical generator.

By the whole duration of the pulse may be meant the entirety of the pulse or the totality of the duration of the pulse.

The peak value of the at least one pulse of the pump signal can vary in an increasing manner over at least one time interval of the at least one pulse of the pump signal and/or can vary in a decreasing manner over at least one time interval of the at least one pulse of the pump signal.

The control unit can be arranged to vary the peak value of the at least one pulse of the pump signal in an increasing manner over at least one time interval of the at least one pulse of the pump signal by modulating the at least one pulse of the pulse signal produced by the electrical generator, preferably by modulating the peak value of the at least one pulse of the pulse signal produced by the electrical generator, and/or in a decreasing manner over at least one time interval of the at least one pulse of the pump signal by modulating the at least one pulse of the pulse signal produced by the electrical generator, preferably by modulating the peak value of the at least one pulse of the pulse signal produced by the electrical generator.

The control unit can be arranged to generate at least one increase and at least one decrease, or vice versa, of the peak value of at least one pulse of the pump signal by modulating the at least one pulse of the pulse signal.

The peak value of the pump signal before the first of the increases of the at least one increase is preferably equal to the value of the pump signal at the end of the rise of the pulse. The peak value of the pump signal after the last of the increases of the at least one increase is preferably equal to the value of the pump signal at the start of the fall of the pulse.

The peak value of the at least one pulse of the pump signal preferably varies alternately or successively in an increasing manner then in a decreasing manner, or vice versa. In other words, the peak value of the at least one pulse of the pump signal can vary so as to form an alternation between, or succession of, a time interval over which the peak value is increasing and a time interval over which the peak value is decreasing, or vice versa.

The peak value of the at least one pulse of the pump signal preferably varies according to a triangular function.

A ratio between:
a rise rate and/or a fall rate of the signal and
a rate of increase of the peak value of the signal, i.e. a rate at which the peak value of the signal grows or increases, and/or a rate of decrease of the peak value of the signal, i.e. a rate at which the peak value of the signal reduces or decreases, can be equal to or greater than two, preferably five, more preferably ten, still more preferably 100 and most preferably 1000.

The rate of increase of the peak value of the signal can be different from the rate of decrease of the peak value of the signal.

A ratio between the rate of the at least one decrease of the peak value of the signal and the rate of the at least one increase of the peak value of the signal is preferably equal to or greater than one, preferably two, still preferably five, more preferably ten,
still more preferably 100 and most preferably 1000.

The rate of the at least one decrease of the peak value of the signal can preferably be equal to the fall rate of the signal.

The rise rate, fall rate, rate of increase and rate of decrease can be defined as the variation of the signal per second. By way of nonlimitative example, the pump signal can be a voltage, an intensity or a luminous flux. Thus, the peak value of the pump signal can be expressed in volts (V), in amps (A) or in watts (W) or in watts per second (W/s), or an arbitrary unit. By way of nonlimitative example, the rise rate, fall rate, rate of increase or rate of decrease can be defined in volts per second or in amps per second or in watts per second.

By way of nonlimitative example, the rise rate (or the rise) and/or the fall rate (or the fall) can be, preferably strictly, greater than or equal to, preferably strictly greater than or equal to, in absolute values, 1.10⁸ amps per second (A/s) and more preferably 1.10⁹ A/s.

By way of nonlimitative example, the rate of increase (or the increase) and/or the rate of decrease (or the decrease) can be smaller than or equal to, preferably strictly smaller than or equal to, in absolute values, 2.10⁸ A/s, preferably 1.10⁷ A/s, more preferably 1.10⁶ A/s. By way of nonlimitative example, the rate of increase (or the increase) and/or the rate of decrease (or the decrease) can be greater than, in absolute values, 1.10⁴ A/s and/or greater than, in absolute values, 1.10⁵ amps per second (A/s).

The variation of the peak value of the signal can be effected at the rise rate over at least one time interval of at least one pulse and/or at the fall rate over at least one time interval of at least one pulse and/or at the rate of increase over at least one time interval of at least one pulse and/or at the fall rate over at least one time interval of at least one pulse.

The variation of the peak value of the pump signal at the rise rate and/or fall rate preferably brings about a nonzero variation of the phase P of the signal amplified and modulated by the SOA.

The variation of the peak value of the pump signal at the rate of increase and/or decrease preferably brings about a zero variation of the phase P of the signal amplified and modulated by the SOA, i.e. a constant phase.

The peak value of the at least one pulse of the pump signal can comprise an average peak value over a time interval of the at least one pulse of the pump signal, preferably over a time interval of the at least one pulse of the pump signal over which the peak value is increasing or decreasing, which is equal to an average peak value over another time interval of the at least one pulse of the pump signal, preferably over a time interval of the pulse of the pump signal over which the peak value is increasing or decreasing.

The control unit can be arranged to vary, preferably by modulating the at least one pulse of the pulse signal, still preferably by modulating the peak value of the at least one pulse of the pulse signal, produced by the electrical generator, the peak value of the at least one pulse of the pump signal such that an average peak value over a time interval of the at least one pulse of the pump signal, preferably over a time interval of the at least one pulse of the pump signal over which the peak value is increasing or decreasing, is equal to an average peak value over another time interval of the at least one pulse of the pump signal, preferably over a time interval of the at least one pulse of the pump signal over which the peak value is increasing or respectively decreasing.

The intervals of the at least one pulse over which the peak value of the at least one pulse of the pump signal is increasing preferably have one and the same average peak value.

The intervals of the at least one pulse over which the peak value of the at least one pulse of the pump signal is decreasing preferably have one and the same average peak value.

The intervals of the at least one pulse over which the peak value of the at least one pulse of the pump signal is increasing and the intervals of the pulse over which the peak value of the at least one pulse of the pump signal is decreasing preferably have an average peak value which is identical. In other words, each of the intervals of the at least one pulse over which the function of the peak value of the at least one pulse of the pump signal is increasing or decreasing can have an average peak value which is identical to each of the peak values of the other intervals of the at least one pulse over which the function of the peak value of the at least one pulse of the pump signal is increasing or decreasing.

The average peak value over a time interval under consideration of the at least one pulse over which the function of the peak value of the at least one pulse of the pump signal is increasing or decreasing is preferably:
identical to an average peak value over an interval of the at least one pulse over which the function of the peak value of the at least one pulse of the pump signal is increasing or decreasing and which chronologically succeeds the time interval under consideration,
identical to an average peak value over an interval of the at least one pulse over which the function of the peak value of the at least one pulse of the pump signal is increasing or decreasing and which chronologically precedes the time interval under consideration.

According to the invention, the average value of a quantity, by way of nonlimitative example the phase of the pulse or the intensity of the pulse, or again the peak value of the pulse or the value of the phase of the pulse or the peak value of the phase of the pulse, over a time interval can be defined as being equal to the arithmetic mean of the entirety of the values taken by the quantity in question over the time interval.

The peak value of the at least one pulse of the pump signal can comprise an average peak value over a time interval of the at least one pulse of the pump signal, preferably over a time interval of the at least one pulse of the pump signal over which the peak value is increasing or decreasing, which is smaller than or greater than an average peak value over another time interval of the at least one pulse of the pump signal, preferably over a time interval of the at least one pulse of the pump signal over which the peak value is increasing or decreasing.

The control unit can be arranged to vary the peak value of the at least one pulse of the pump signal, preferably by modulating the at least one pulse of the pulse signal, still preferably by modulating the peak value of the at least one pulse of the pulse signal, produced by the electrical generator, such that an average peak value over a time interval of the at least one pulse of the pump signal, preferably over a time interval of the at least one pulse of the pump signal over which the peak value is increasing or decreasing, is smaller than or greater than an average peak value over another time interval of the at least one pulse of the pump signal, preferably over a time interval of the at least one pulse of the pump signal over which the peak value is increasing or decreasing.

The intervals of the at least one pulse over which the peak value of the at least one pulse of the pump signal is increasing preferably each have a different average peak value, i.e. greater or smaller.

The intervals of the at least one pulse over which the peak value of the at least one pulse of the pump signal is decreasing preferably each have a different average peak value.

The intervals of the at least one pulse over which the peak value of the at least one pulse of the pump signal is increasing preferably have an average peak value which is different from the average peak value of the intervals of the at least one pulse over which the peak value of the at least one pulse of the pump signal is decreasing.

The average peak value over a time interval under consideration of the at least one pulse over which the peak value of the at least one pulse of the pump signal is increasing, or respectively decreasing, is preferably:
greater, or preferably smaller, than an average peak value over a time interval of the at least one pulse over which the peak value of the at least one pulse of the pump signal is increasing, or respectively decreasing, and which chronologically succeeds the time interval under consideration,
smaller, or preferably greater, than an average peak value over a time interval of the at least one pulse over which the peak value of the at least one pulse of the pump signal is increasing, or respectively decreasing, and which chronologically precedes the time interval under consideration.

The average peak value over a time interval under consideration of the at least one pulse over which the peak value of the at least one pulse of the pump signal is increasing or decreasing is preferably:
greater, or preferably smaller, than an average peak value over a time interval of the at least one pulse over which the peak value of the at least one pulse of the pump signal is increasing or decreasing and which chronologically succeeds the time interval under consideration,
smaller, or preferably greater, than an average peak value over a time interval of the at least one pulse over which the peak value of the at least one pulse of the pump signal is increasing or decreasing and which chronologically precedes the time interval under consideration.

The control unit can comprise at least one switch arranged to control and/or modulate the pulse signal.

The at least one switch can be a transistor. The transistor can be a metal-oxide-semiconductor field-effect transistor, denoted MOS. The transistor can be n-type, i.e. an nMOS transistor, or p-type, i.e. a pMOS transistor.

The at least one switch can be arranged to vary the pump signal by modulating and/or switching the pulse signal emitted by the electrical generator.

The LiDAR can comprise a fibre optic amplifier arranged to amplify the master laser beam amplified and modulated by the SOA.

The LiDAR, or a control unit of the LiDAR or the SOA, can be arranged to vary a peak value, preferably in a linear increasing or decreasing manner, of the master laser beam amplified and modulated by the SOA.

The LiDAR, or a control unit of the LiDAR or the SOA, can preferably be arranged to vary a peak value, preferably in a linear increasing or decreasing manner, of the master laser beam amplified and modulated by the SOA such that the signal, or the average signal or the power or the average power, of the laser beam amplified by the fibre optic amplifier, i.e. the master laser beam amplified and modulated by the SOA then amplified by the fibre optic amplifier, is constant over the at least one pulse.

According to the invention, a method of amplifying a master laser beam of a pulsed LiDAR is also proposed, comprising the steps consisting of:
generating a pump signal, preferably by means of a pulse generator, comprising at least one pulse, a peak value of which varies over the course of said at least one pulse of said pump signal, preferably generating a pump signal comprising at least one pulse, the peak value, a rise and/or a fall of which varies over the course of said at least one pulse of said pump signal, and/or, preferably, keeping a phase of at least one pulse of the signal amplified and modulated by the SOA constant or varying it,
amplifying and modulating the master laser beam by means of a semiconductor optical amplifier (SOA) of the pulsed LiDAR as a function of the generated pump signal, the amplified and modulated master laser beam forming a measurement laser beam.

The method can comprise the step consisting of varying the peak value of the at least one pulse of the pump signal by modulating, preferably by means of a control unit, at least one pulse of a pulse signal, preferably by modulating a peak value, a rise and/or a fall of at least one pulse of the pulse signal, able to be produced by an electrical generator.

The method can preferably comprise the step consisting of varying, preferably by means of the pulse generator, a phase and/or a frequency of the signal amplified and modulated by the SOA by modulating the at least one pulse of the pump signal, preferably by modulating the peak value, the rise and/or the fall of the at least one pulse of the pump signal, still preferably by modulating the variation of the peak value of the at least one pulse of the pump signal.

The method can preferably comprise the step consisting of varying, preferably by means of the control unit, a phase and/or a frequency of the signal amplified and modulated by the SOA by modulating the at least one pulse of the pulse signal, preferably by modulating the rise and/or the fall of the at least one pulse of the pulse signal, still preferably by modulating the peak value of the at least one pulse of the pulse signal.

The method can comprise the step consisting of varying the phase of the at least one pulse of the signal amplified and modulated by the SOA, preferably by modulating the pulse signal, preferably by means of the control unit.

The method can comprise the steps consisting of:
keeping the phase of the at least one pulse of the signal amplified and modulated by the SOA constant preferably by modulating the pulse signal, preferably by means of the control unit, or
varying, preferably by modulating the pulse signal, preferably by means of the control unit, the phase of the at least one pulse of the signal amplified and modulated by the SOA in an increasing manner, preferably over at least one time interval of the at least one pulse, and/or in a decreasing manner, preferably over at least one time interval of the at least one pulse of the signal amplified and modulated by the SOA.

The method can comprise the step consisting of shifting a frequency of the at least one pulse of the signal amplified and modulated by the SOA in proportion to a variation gradient of the phase of the at least one pulse of the signal amplified and modulated by the SOA over the at least one time interval of the at least one pulse over which the phase is increasing or decreasing.

The method can comprise the step consisting of varying the phase of the at least one pulse of the signal amplified and modulated by the SOA such that an average value of the phase over a time interval of the at least one pulse of the signal amplified and modulated by the SOA, preferably over a time interval of the at least one pulse of the signal amplified and modulated by the SOA over which the phase is increasing or respectively decreasing, is equal to an average value of the phase over another time interval of the at least one pulse of the signal amplified and modulated by the SOA, preferably over a time interval of the at least one pulse of the signal amplified and modulated by the SOA over which the phase is increasing or respectively decreasing.

The method can comprise the step consisting of varying the phase of the at least one pulse of the signal amplified and modulated by the SOA such that an average value of the phase over a time interval of the pulse of the signal amplified and modulated by the SOA, preferably over a time interval of the pulse of the signal amplified and modulated by the SOA over which the phase is increasing or respectively decreasing, is smaller than or greater than an average value of the phase over another time interval of the pulse of the signal amplified and modulated by the SOA, preferably over a time interval of the pulse over which the phase is increasing or respectively decreasing.

The method can comprise the step consisting of varying the phase of the at least one pulse of the signal amplified and modulated by the SOA such that, for at least one pulse under consideration, a value of the phase varies by modulo 2n over at least one time interval of the at least one pulse under consideration of the signal amplified and modulated by the SOA, i.e. the value of the phase varies by modulo 2n at least once over the course of the at least one pulse under consideration of the signal amplified and modulated by the SOA.

The method can preferably comprise the step consisting of varying the phase of the at least one pulse of the signal amplified and modulated by the SOA such that, for at least one pulse under consideration, a value of the phase varies by modulo 2n over several time intervals of the at least one pulse under consideration of the signal amplified and modulated by the SOA, i.e. the value of the phase varies by modulo 2n several times over the course of the at least one pulse of the signal amplified and modulated by the SOA.

The method can comprise the step consisting of varying the phase of the at least one pulse of the signal amplified and modulated by the SOA such that an average value of the phase P over a time interval under consideration of the at least one pulse over which the phase is increasing, or respectively decreasing, is:
identical to the average peak value over an interval of the at least one pulse which chronologically succeeds the time interval under consideration,
identical to the average peak value over an interval of the at least one pulse which chronologically precedes the time interval under consideration.

The method can comprise the step consisting of varying the phase of the at least one pulse of the signal amplified and modulated by the SOA such that an average value of the phase P over a time interval under consideration of the at least one pulse over which the phase is increasing, or respectively decreasing, is
smaller than or greater than the average value of the phase P over a time interval of the at least one pulse over which the phase is increasing, or respectively decreasing, and which chronologically succeeds the time interval under consideration,
greater than or smaller than the average value of the phase P over a time interval of the at least one pulse over which the phase is increasing, or respectively decreasing, and which chronologically precedes the time interval under consideration.

The peak value of the pump signal can vary, preferably by modulating the pulse signal, preferably by means of the control unit, such that, over the course of a pulse of a signal amplified and modulated by the SOA, a phase of the signal amplified and modulated by the SOA:
is constant or kept constant, or
is increasing over at least one time interval of the pulse and is decreasing over at least one time interval of the pulse.

The peak value of the pump signal can vary such that, over the course of the at least one pulse of a signal amplified and modulated by the SOA, an average value of the phase over a time interval of the at least one pulse of the signal amplified and modulated by the SOA, preferably over a time interval of the at least one pulse of the signal amplified and modulated by the SOA over which the phase is increasing or respectively decreasing, is equal to an average value of the phase over another time interval of the at least one pulse of the signal amplified and modulated by the SOA, preferably over a time interval of the at least one pulse of the signal amplified and modulated by the SOA over which the phase is increasing or respectively decreasing.

The peak value of the pump signal can vary such that, over the course of a pulse of a signal amplified and modulated by the SOA, an average value of the phase over a time interval of the at least one pulse of the signal amplified and modulated by the SOA, preferably over a time interval of the at least one pulse of the signal amplified and modulated by the SOA over which the phase is increasing or respectively decreasing, is smaller than or greater than an average value of the phase over another time interval of the at least one pulse of the signal amplified and modulated by the SOA, preferably over a time interval of the at least one pulse of the signal amplified and modulated by the SOA over which the phase is increasing or respectively decreasing.

The peak value of the at least one pulse of the pump signal can:
vary monotonically over at least one time interval of the at least one pulse of the pump signal, and/or
be increasing over at least one time interval of the at least one pulse of the pump signal and/or be decreasing over at least one time interval of the at least one pulse of the pump signal.

The at least one time interval of the at least one pulse of the pump signal over which the peak value varies monotonically and/or the at least one time interval of the at least one pulse of the pump signal over which the peak value is increasing and/or the at least one time interval of the at least one pulse of the pump signal over which the peak value is deincreasing can be all or part of the total duration of the at least one pulse of the pump signal.

The variation of the peak value of the at least one pulse of the pump signal can comprise, or be or consist of, a triangular signal.

The peak value of the at least one pulse of the pump signal can vary monotonically over the whole duration of the at least one pulse of the pump signal.

A frequency of at least one pulse of the signal amplified and modulated by the SOA can be shifted, adjusted or modulated as a function of a gradient of the peak value of the at least one pulse of the pump signal over the at least one time interval of the at least one pulse of the pump signal over which the peak value is increasing and/or as a function of a gradient of the peak value of the at least one pulse of the pump signal over the at least one time interval of the at least one pulse of the pump signal over which the peak value is decreasing.

The frequency of at least one pulse of the signal amplified and modulated by the SOA is preferably shifted:
by varying the peak value of the at least one pulse of the pump signal, preferably the peak value, the rise and/or the fall of the at least one pulse of the pump signal, and/or
by modulating, preferably by means of the control unit, the at least one pulse of the pulse signal, still preferably the peak value, the rise and/or the fall of at least one pulse of the pulse signal, being able to be produced by an electrical generator.

The “gradient of the peak value of the at least one pulse of the pump signal” can be the leading coefficient of the peak value of the at least one pulse of the pump signal over which the function is increasing or decreasing.

The gradient of the peak value of the pump signal is preferably identical over each of the time intervals of the pulse over which the peak value is increasing or decreasing.

The peak value of the at least one pulse of the pump signal is preferably increasing over at least one time interval of the at least one pulse of the pump signal and decreasing over at least one time interval of the at least one pulse of the pump signal such that a frequency of the at least one pulse of the signal amplified and modulated by the SOA is shifted, adjusted or modulated as a function of the peak value of the at least one pulse of the pump signal.

The peak value of the at least one pulse of the pump signal is preferably increasing over at least one time interval of the at least one pulse of the pump signal and decreasing over at least one time interval of the at least one pulse of the pump signal such that a frequency of the at least one pulse of the signal amplified and modulated by the SOA is shifted, adjusted or modulated as a function of, preferably in proportion to, the rate of variation of the peak value of the at least one pulse of the pump signal.

Preferably:
the peak value of the at least one pulse of the pump signal is increasing over at least one time interval of the at least one pulse of the pump signal and decreasing over at least one time interval of the at least one pulse of the pump signal, and
a variation of the peak signal, over the at least one time interval over which the peak signal is increasing, or respectively decreasing, is greater, in absolute values, than 1.10⁸ amps per second (A/s) and more preferably than 1.10⁹ A/s or else than 1.10¹⁰ A/s, and
a variation of the peak signal, over the at least one time interval over which the peak signal is decreasing, or respectively increasing, is smaller, in absolute values, than 1.10⁸ amps per second (A/s) and more preferably smaller than or equal to 1.10⁷ A/s; preferably a variation of the peak signal, over the at least one time interval over which the peak signal is decreasing, or respectively increasing, at a rate, called rate of variation of the peak value, which is greater, in absolute values, than 1.10⁴ amps per second (A/s), preferably than 1.10⁵ amps per second (A/s), and/or preferably smaller than or equal to 1.10⁶ A/s, more preferably smaller than or equal to 1.10⁷ A/s and
still more preferably smaller than 1.10⁸ A/s,
such that a frequency of the at least one pulse of the signal amplified and modulated by the SOA is shifted, adjusted or modulated as a function of the rate of variation of the peak value of the at least one pulse of the pump signal or, preferably, is or tends to be shifted, adjusted or modulated in proportion to the rate of variation of the peak value of the at least one pulse of the pump signal.

The peak value of the at least one pulse of the pump signal can comprise an average peak value over at least one time interval of the at least one pulse of the pump signal, preferably over the at least one time interval over which the peak value is increasing or over the at least one time interval over which the peak value is decreasing, which is equal to an average peak value over at least one other time interval of the at least one pulse of the pump signal, preferably over the at least one time interval over which the peak value is increasing or over the at least one time interval over which the peak value is decreasing.

The peak value of the at least one pulse of the pump signal can vary, preferably by modulating, preferably by means of the control unit, the at least one pulse of the pulse signal, still preferably by modulating the peak value, the rise and/or the fall of the at least one pulse of the pulse signal, being able to be produced by an electrical generator, such that an average peak value over at least one time interval of the at least one pulse of the pump signal, preferably over the at least one time interval over which the peak value is increasing or over the at least one time interval over which the peak value is decreasing, is equal to an average peak value over at least one other time interval of the at least one pulse of the pump signal, preferably over the at least one time interval over which the peak value is increasing or over the at least one time interval over which the peak value is decreasing.

The peak value of the at least one pulse of the pump signal can comprise an average peak value over at least one time interval of the at least one pulse of the pump signal, preferably over the at least one time interval over which the peak value is increasing or over the at least one time interval over which the peak value is decreasing, which is smaller than or greater than an average peak value over at least one other time interval of the at least one pulse of the pump signal, preferably over the at least one time interval over which the peak value is increasing or over the at least one time interval over which the peak value is decreasing.

The peak value of the at least one pulse of the pump signal can vary, preferably by modulating, preferably by means of the control unit, the at least one pulse of the pulse signal, still preferably the peak value, the rise and/or the fall of at least one pulse of the pulse signal, being able to be produced by an electrical generator, such that an average peak value over at least one time interval of the at least one pulse of the pump signal, preferably over the at least one time interval over which the peak value is increasing or over the at least one time interval over which the peak value is decreasing, is smaller than or greater than an average peak value over at least one other time interval of the at least one pulse of the pump signal, preferably over the at least one time interval over which the peak value is increasing or over the at least one time interval over which the peak value is decreasing.

The method can comprise a measurement of data relating to a phase of the signal amplified and modulated by the SOA.

The measurement of data of the phase of the signal amplified and modulated by the SOA can be performed by a phase quadrature detector, coherent detector or phase quadrature optical demodulator.

The method can comprise a determination of the modulation of the at least one pulse of the pulse signal and/or the variation of the at least one pulse of the pump signal on the basis of data:
relating to the phase of the signal amplified and modulated by the SOA, and
data of the peak value of the at least one pulse of the pump signal as a function of which the master laser beam is amplified and modulated.

The method can be implemented without, i.e. possibly does not comprise, the step of calibrating the peak value, i.e. the step of determining the modulation of the at least one pulse of the pulse signal and/or the variation of the at least one pulse of the pump signal.

The method possibly does not comprise the step of measuring or determining the data relating to the phase of the signal amplified and modulated by the SOA. These data can be collected prior to and/or independently of the method according to the invention. The data relating to the phase of the signal amplified and modulated by the SOA can be data stored, received or transmitted, for example to the control unit during the implementation of the method according to the invention. For example, the data relating to the phase of the signal amplified and modulated by the SOA can be data stored in a storage device of a computer medium.

The data relating to the phase of the signal amplified and modulated by the SOA can be determined and/or measured, preferably during the implementation of the method according to the invention.

In other words, the step of calibrating can be implemented independently of the method and the method can be implemented without the step of determining the modulation of the pulse signal or the variation of the pump signal.

By “determining the modulation of the at least one pulse of the pulse signal and/or the variation of the at least one pulse of the pump signal” may be meant the determination of the modulation to be applied to the pulse signal and/or the determination of the variation to be applied to the pump signal.

The determination of the modulation of the pulse signal and/or the variation of the pump signal, to be applied, can comprise, or be or consist of, calibrating the modulation and/or the variation.

The determination of the modulation of the pulse signal and/or the variation of the pump signal can comprise the step consisting of adjusting, adapting or regulating the modulation of the pulse signal applied and/or the variation of the pump signal applied.

According to a first variant, the determination of the modulation of the pulse signal and/or the variation of the pump signal can comprise the steps consisting of:
modulating the pulse signal, preferably the peak value, the rise and/or the fall of the at least one pulse of the pulse signal, and/or modulating the variation of the pump signal, preferably the variation of the peak value, rise and/or fall of the at least one pulse of the pump signal, and/or
amplifying and modulating the master laser beam, by means of the SOA, as a function of the pump signal, and
adjusting, adapting or regulating the modulation of the pulse signal applied and/or the modulation of the variation of the pump signal applied.

According to a second variant, the determination of the modulation of the peak value can comprise the steps consisting of:
modulating a reference pulse signal, the peak value of which is preferably constant, still preferably a square pulse signal, still preferably the peak value, the rise and/or the fall of at least one pulse of the reference pulse signal, and/or modulating the variation of the pump signal, preferably the variation of the peak value, rise and/or fall of the at least one pulse of the pump signal, and
determining the modulation of the at least one pulse of the pulse signal to be applied and/or the variation of the at least one pulse of the pump signal to be applied.

The method can comprise the step consisting of amplifying, by means of a fibre optic amplifier, the master laser beam amplified and modulated by the SOA.

The method can comprise the step consisting of compensating or modulating or adapting or modifying, preferably by means of a control unit of the LIDAR or the SOA, the amplification of the master laser beam operated by the SOA as a function of or in relation to the amplification of the amplified and modulated master laser beam operated by the fibre optic amplifier.

The device according to the invention is suitable, preferably is arranged, still preferably is specially designed, to implement the method according to the invention.

The method according to the invention can, preferably is specially designed to, be implemented by the device according to the invention.

### DESCRIPTION OF THE FIGURES

Other advantages and features of the invention will become apparent on reading the detailed description of implementations and embodiments that are in no way limitative, and from the following attached drawings:

FIG. 1 illustrates a diagrammatic representation of the experimental setup, of the Mach Zehnder type, used to determine the development of the phase and the amplitude of the master laser beam amplified and modulated by the SOA,

FIG. 2 illustrates the development, averaged over 1000 pulses, of the intensity and the phase of the signal amplified and modulated by the SOA obtained on the basis of a square pump signal,

FIGS. 3a and 3b illustrate the development, over an average of 1000 pulses, of the intensity, the phase P and the frequency f of the amplified and modulated signal 2 obtained on the basis of a square pump signal, and FIGS. 3c and 3d illustrate the power spectral density obtained (logarithmic and linear scale), by coherent detection on the basis of a square pump signal, as a function of the spectrum of frequencies integrated over the duration of the pulse,

FIGS. 4a and 4b illustrate the development, over an average of 1000 pulses, of the intensity, the phase P and the frequency of the amplified and modulated signal 2 obtained on the basis of a pump signal of which the peak value of the pulses is modulated, and FIGS. 4c and 4d illustrate the power spectral density obtained, by coherent detection on the basis of a pump signal of which the peak value of the pulses is modulated, as a function of the spectrum of frequencies integrated over the duration of the pulse,

FIGS. 5a and 5b illustrate the development, over an average of 1000 pulses, of the intensity, the phase P and the frequency of the amplified and modulated signal 2 obtained on the basis of a pump signal of which the peak value of the pulses is modulated, and FIGS. 5c and 5d illustrate the power spectral density obtained, by coherent detection on the basis of a pump signal of which the peak value of the pulses is modulated, as a function of the spectrum of frequencies integrated over the duration of the pulse,

FIG. 6 is a diagrammatic representation of a pulsed LiDAR for coherent detection,

FIG. 7a represents the development of the intensity of the square pump signal which is injected into the SOA 3, FIG. 7b represents the development, over the course of the pulse, of the power of the signal 2 amplified and modulated by the SOA 3 obtained on the basis of the square pump signal of FIG. 7a, FIG. 7c represents the development, over the course of the pulse, of the frequency of the signal 2 amplified and modulated by the SOA 3 obtained on the basis of the square pump signal of FIG. 7a, and FIG. 7d illustrates the power spectral density obtained, by coherent detection on the basis of a square pump signal, as a function of the spectrum of frequencies integrated over the duration of the pulse,

FIG. 8 is a diagrammatic representation of the embodiments of the control unit comprising one or more switches arranged to control the pump signal,

FIG. 9a represents the development of the intensity of the pump signal which is injected into the SOA 3, FIG. 9b represents the development, over the course of the pulse, of the power of the signal 2 amplified and modulated by the SOA 3 obtained on the basis of the pump signal of which the peak value of the pulses is modulated as illustrated in FIG. 9a, FIG. 9c represents the development, over the course of the pulse, of the frequency of the signal 2 amplified and modulated by the SOA 3 obtained on the basis of the pump signal of which the peak value of the pulses is modulated as illustrated in FIG. 9a, and FIG. 9d illustrates the power spectral density obtained, by coherent detection on the basis of the pump signal of which the peak value of the pulses is modulated as illustrated in FIG. 9a, as a function of the spectrum of frequencies integrated over the duration of the pulse,

FIG. 10a represents the development of the intensity of the pump signal which is injected into the SOA 3, FIG. 10b represents the development, over the course of the pulse, of the power of the signal 2 amplified and modulated by the SOA 3 obtained on the basis of the pump signal of which the peak value of the pulses is modulated as illustrated in FIG. 10a, FIG. 10c represents the development, over the course of the pulse, of the frequency of the signal 2 amplified and modulated by the SOA 3 obtained on the basis of the pump signal of which the peak value of the pulses is modulated as illustrated in FIG. 10a, and FIG. 10d illustrates the power spectral density obtained, by coherent detection on the basis of the pump signal of which the peak value of the pulses is modulated as illustrated in FIG. 10a, as a function of the spectrum of frequencies integrated over the duration of the pulse.

### DESCRIPTION OF THE EMBODIMENTS

As the embodiments described hereinafter are in no way limitative, variants of the invention can in particular be considered comprising only a selection of the characteristics described, in isolation from the other characteristics described (even if this selection is isolated within a phrase comprising these other characteristics), if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

FIG. 1 illustrates the experimental setup 1 used to characterize the properties of the master laser beam 2 amplified and modulated by the SOA 3 as a function of a pump signal 4. The setup 1 comprises a laser diode 5, “Emcore DFB-CW-FC-PM” sold by the company “Ixblue”, continuously emitting a master laser beam with a wavelength of 1545 nm, corresponding to a frequency of 194 THz, called reference frequency f_{ref}.

The SOA 3 used is a semiconductor optical amplifier, “BOA1004P” sold by the company “Thorlabs”. The master laser beam 6 emitted by the diode 5 is divided into two beams 61, 62 by a “50/50” splitter 71 or coupler sold by the company “AFR”. The beam 61 is used as local oscillator 61 and is injected into a phase quadrature demodulator 8, “Kylia COH24” sold by the company “Kylia”. The beam 62 is attenuated by an attenuator 9, 91 or fibre optic attenuator sold by the company “AFR”, in order not to saturate the SOA 3.

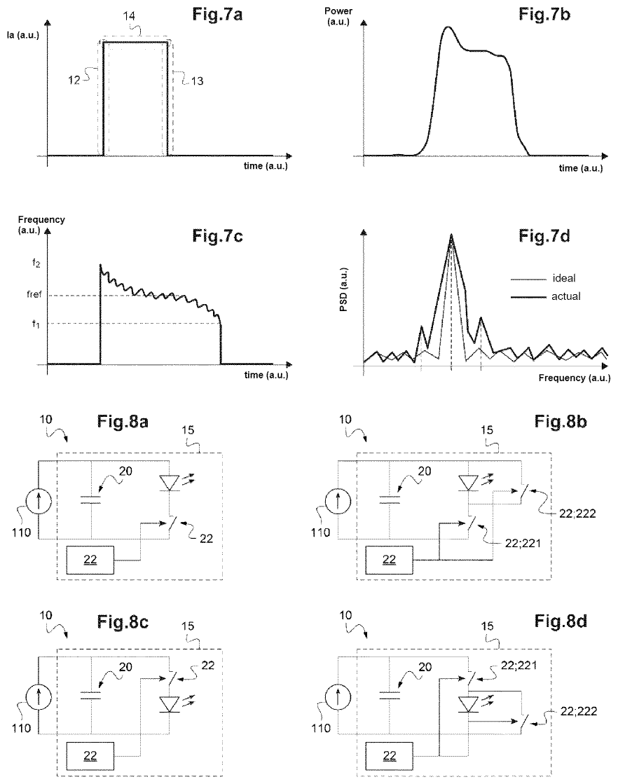

A pulse generator 10 comprising an electrical generator 110, “BFS-VRM-03”, trade mark Picolas, 2.5 amps (A), 5 volts (V), which generates an electrical current in the form of square pulse signals such as represented in FIG. 7a. The SOA 3 couples together the functions of modulation and amplification. The pump signal 4 according to the embodiment is generated by the pulse generator 10. The pulses of the pump signal 4 generated by the pulse generator 10 have a peak value which varies over the course of the pulse. The control unit 15 according to the invention varies the pump signal by modulating the square pulse signals (represented in FIG. 7a) emitted by the electrical generator 110. The master laser beam 6 is amplified and modulated, by the SOA 3, as a function of the pump signal 4 which is injected into the SOA 3. The amplified and modulated beam 2 is attenuated by an attenuator 9, 92 so as not to saturate the detector 11. The amplified, modulated and attenuated beam 21 is divided into two by an additional coupler 72. A part of the amplified, modulated and attenuated beam 21 is injected into the phase quadrature optical demodulator 8.

The intensity of the other part of the amplified, modulated and attenuated beam 21, denoted Iₐ, is measured by the detector 11, “DET01CFC” sold by the company “Thorlabs”. As a result, the intensity of the amplified and modulated beam 2, denoted Iₘ, is in proportion to the intensity Iₐ 21. A factor k links the intensity Iₐ to Iₘ according to the following relationship:

$${I}_{a} = k \cdot {I}_{m} . \qquad formula 1$$

A balanced detector 23, “PDB480C-AC”, trade mark “Thorlabs”, is coupled to the demodulator 8 to measure the bands of the signal 21 amplified, modulated and attenuated in terms of phase and quadrature with the signal of the local oscillator 61. Thus, it is possible to follow the development of the phase, denoted P, and the intensity Iₐ of the amplified and modulated signal 2 during the pulse.

The intensity measurement performed by the detector 11 and the phase measurements P performed by the demodulator 8, as described with reference to FIG. 1, are not necessary for implementing the method according to the invention. The method according to the invention has the advantage of not requiring such measurements, in particular for determining the direction of the wind speed. The measurements described have the aim of demonstrating the technical benefits and advantages of the invention vis-à-vis LiDARs of the state of the art. However, it is not ruled out that the method comprises such measures.

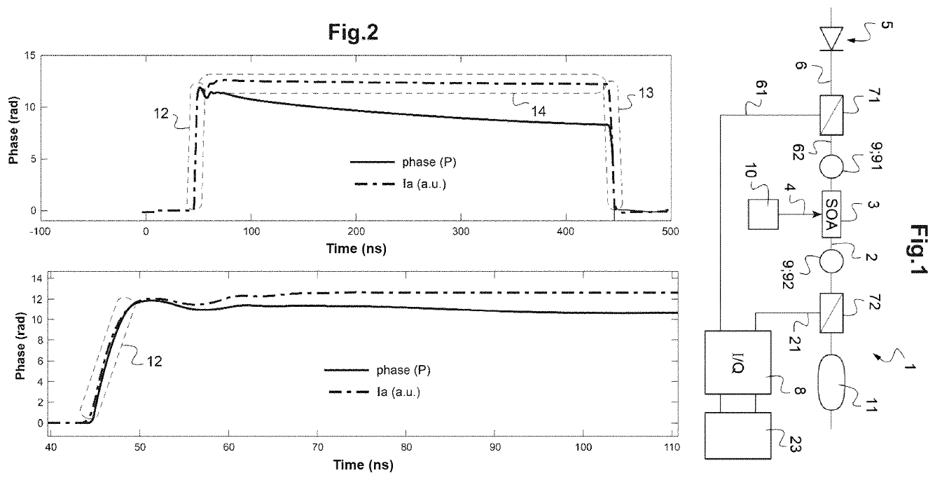

The amplified and modulated signals 2 presented in FIGS. 2 to 4 were obtained using a square pump signal 4 of 400 nanoseconds (ns) and an intensity of 0.6 A, injected into the SOA 3 in order to modulate and amplify the master laser beam 6. The peak value 14 of the “conventional” or “standard” square pump signal 4, as used in the state of the art, is constant over the whole duration of the pulse. Each pulse of the pump signal 4 comprises a rise 12 of the signal, a peak signal 14 and a fall 13 of the signal.

FIG. 2 illustrates the development of the intensity Iₐ in arbitrary units (a.u.) and the phase P in radians (rad) of the amplified and modulated signal 2 averaged over 1000 pulses. It is in fact noted that the phase P follows the intensity Iₐ of the signal in the first tens of nanoseconds. The phase P then deviates from the intensity Iₐ of the amplified and modulated signal 2. FIG. 2b is zoomed in on the first eighty nanoseconds of the pulse of FIG. 2a. The phase P of the pulse, in radians (rad), is plotted on the y axis and the time in seconds (s) is plotted on the x axis.

It is to be noted that the values of the phase P when the intensity Iₐ is zero do not have a direction. This observation is valid for the entirety of the description.

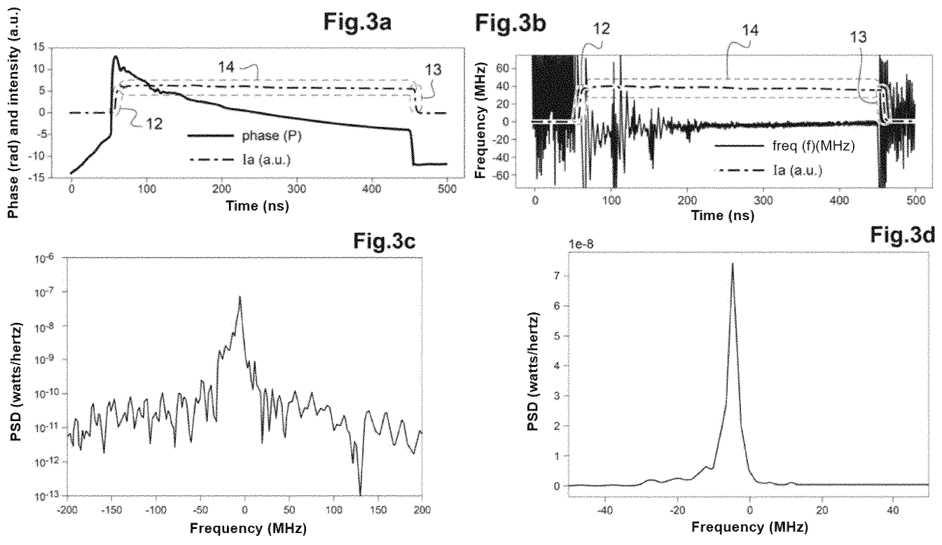

The development of the intensity Iₐ, and the phase P, of the amplified and modulated signal 2 averaged over 1000 pulses is represented in FIG. 3a. The pump signal 4 injected into the SOA 3, to amplify and modulate the master laser beam 6, is a square signal. The development of the phase P follows the same trend as that of FIG. 2. Moreover, it is noted here that the intensity Iₐ of the amplified and modulated signal 2 is subject to not insignificant variations in the first half of the pulse. The phase P of the pulse, in radians, is plotted on the y axis and the time, in seconds, is plotted on the x axis. The intensity Iₐ of the amplified and modulated signal 2 is in arbitrary units.

The, instantaneous, development of the intensity Iₐ and of the frequency f of the amplified and modulated signal 2 averaged over 1000 pulses is represented in FIG. 3b. The frequency f of the amplified and modulated signal 2 was calculated on the basis of the phase data of FIG. 3 according to the formula:

$$f = \frac{1}{2 p i} * d ( P ) / dt . \qquad formula 2$$

The frequency f of the pulse, in megahertz (MHZ), is plotted on the y axis and the time, in seconds, is plotted on the x axis. The intensity Iₐ of the amplified and modulated signal 2 is in arbitrary units.

A resultant variation of the frequency f of the amplified and modulated signal 2 during the rise 12 and the fall 13 is noted. Moreover, the frequency f of the amplified and modulated signal 2 is unstable during the entirety of the pulse.

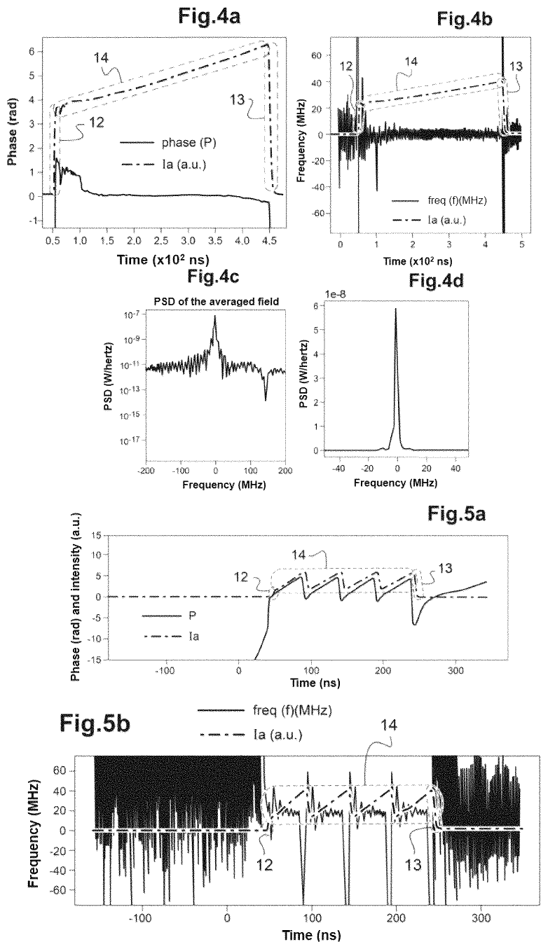

The spectrum of frequencies integrated over the duration of the pulse obtained by coherent detection on the basis of the amplified and modulated pulse signal 2, obtained by linearly varying the peak value 14 of the pump signal 4, and the local oscillator 61, is represented in FIGS. 3c and 3d. The power spectral density, in terms of relative amplitude, is illustrated there as a logarithmic scale for FIG. 3c and as a linear scale for FIG. 3d, on the y axis, as a function of the frequency, in MHz, on the x axis. The shift induced by the SOA corresponds to the shift between the reference frequency f_{ref} of the master laser beam 6, i.e. the local oscillator 61, and the frequency f of the amplified and modulated signal 2. With reference to FIGS. 4c and 4d, a shift induced by the SOA of 2.2 MHZ resulting from the variation of the phase of the amplified and modulated signal 2 during the pulse is observed. This phase variation is frequent but not systematic. Moreover, it is uncontrollable and depends on the drift of the phase of the amplified and modulated signal 2. This phase variation of the amplified and modulated signal 2 also causes a broadening of the frequency peak observed, the appearance of one or more lobe(s) at the base of this peak, or more generally a deformation of this peak (see FIG. 3d).

In order to overcome the different problems above, and in particular in order to alleviate the frequency shift of the peak induced by the drift of the phase of the amplified and modulated signal 2 during the pulse, the solution provided by the invention is to keep the phase P of the signal 2 amplified and modulated by the SOA 3 constant, or as constant as possible, during the pulse. In order to do this, it is possible, for example, to vary the peak value 14 of the pulses of the pump signal 4 by means of the pulse generator 10 and the pulsed LiDAR 1 according to the invention, a particular embodiment of which is presented in FIG. 8 and described below.

According to a particular embodiment, the modulation of the peak value 14 consists of varying the peak value 14 of the pump signal 4 according to a monotonic function throughout the duration of the pulse. The amplified and modulated signals 2 presented in FIG. 4 were obtained using a pump signal 4 of 400 nanoseconds (ns) and an intensity of 0.6 A, injected into the SOA 3 to modulate and amplify the master laser beam 6, in which the peak value 14 varies linearly in an increasing manner over the entirety of the duration of the pulse. In this case, the function defining the peak value 14 of the pump signal 4 is increasing and monotonic over the time interval of the pulse.

The development of the phase P as a function of time is illustrated in FIG. 4a. The intensity Iₐ, in arbitrary units, of the pulse signal 2 amplified and modulated by the SOA 3 measured by the demodulator 8 are also represented.

It is observed that the injection of a linear current ramp, for example increasing, as peak value 14 of the pump signal 4 into the SOA 3 makes it possible to obtain a phase P of the amplified and modulated pulse signal 2 that is almost constant. The phase P has a variation smaller than 0.3 radians over the duration of the pulse, contrary to a variation of 6 radians over the duration of the pulse in the case of a square pump signal as presented in FIG. 3a.

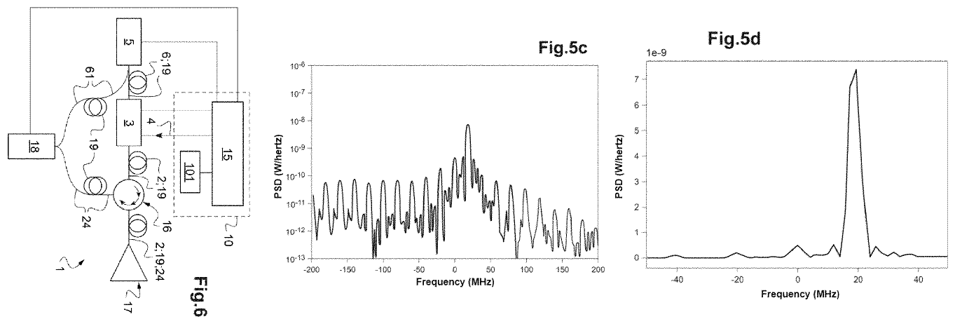

FIG. 4b represents the development of the frequency f of the amplified and modulated pulse signal 2, calculated on the basis of the phase data of FIG. 5a according to formula 2, over the course of the pulse. The frequency f of the pulse, in megahertz (MHz), is plotted on the y axis and the time, in seconds, is plotted on the x axis.

The spectrum of frequencies integrated over the duration of the pulse obtained by coherent detection on the basis of the amplified and modulated pulse signal 2, obtained by linearly varying the peak value 14 of the pump signal 4, and the local oscillator 61, is represented in FIGS. 4c and 4d. The power spectral density, in terms of relative amplitude, is illustrated there as a log scale for FIG. 4c and as a linear scale for FIG. 4d, on the y axis, as a function of the frequency, in MHz, on the x axis. With reference to FIGS. 4c and 4d, and compared with a square pump signal 4, the use of a pump signal the peak value of which is a linear current ramp makes it possible to obtain a peak centred at the frequency 0, i.e. without shift induced by the SOA, over the frequency of the master laser beam 6.

Moreover, this also makes it possible to reduce the broadening of the peak measured and to attenuate the lobes at its base.

In order to overcome the different problems above, and in particular in order to be able to determine the sign of the wind speed without having to use an additional device such as an AOM or a phase quadrature demodulator, the solution provided by the invention is to vary a phase P of a pulse of the signal 2 amplified and modulated by the SOA 3 according to a function which is increasing over at least one time interval of the pulse and which is decreasing over at least one time interval of the pulse. According to the embodiment, the phase P increases and decreases so as to form a triangular signal. In order to do this, it is possible, for example, to modulate the peak value 14 of the pulses of the pump signal 4 by means of the pulse generator 10 of the pulsed LiDAR 1.

According to a particular embodiment, the modulation of the peak value 14 consists of varying the peak value 14 of at least one pulse of the pump signal 4 according to a function which is increasing over at least one time interval of the pulse and which is decreasing over at least one time interval of the pulse.

In practice, the peak value 14 of the pump signal 4 resembles a triangular signal 14. The amplified and modulated signals 2 presented in FIG. 5 were obtained using a pump signal 4 of 400 nanoseconds (ns) and an intensity of 0.6 A, injected into the SOA 3 to modulate and amplify the master laser beam 6, in which the peak value 14 forms a triangular signal. The triangular peak value 14 of the pump signal 4 comprises a linear increase of the intensity from 0.4 A up to 0.6 A over a time interval of 80 ns and a linear decrease of the intensity from 0.6 A down to 0.4 A over a time interval of 20 ns. In practice, the triangular pump signal 4 comprises four triangles over the course of a pulse. Moreover, the peak value 14 at the end of the rise 12 of a triangle under consideration is equal to the peak value 14 at the end of the rise 12 of a triangle which, chronologically, precedes the triangle under consideration. Moreover, the peak value 14 at the end of the fall 13 of a triangle under consideration is equal to the peak value 14 at the end of the fall 13 of a triangle which, chronologically, precedes the triangle under consideration.

The development of the phase as a function of time is illustrated in FIG. 5a. The intensity Iₐ, in arbitrary units, of the pulse signal 2 amplified and modulated by the SOA 3 measured by the demodulator 8 is also represented. FIG. 5b represents the development of the frequency f of the amplified and modulated pulse signal 2, calculated on the basis of the phase data of FIG. 5a according to formula 2, over the course of the pulse. The frequency f of the pulse, in megahertz (MHZ), is plotted on the y axis and the time, in seconds, is plotted on the x axis.

The modulation of the peak value 14 of the pulse of the pump signal 4 comprises a variation of the peak value 14. This variation of the peak value 14 is such that an average peak value 14 over a time interval of the pulse over which the function is increasing or decreasing is equal to each of the other average peak values 14 of each of the other time intervals of the pulse over which the function is increasing or decreasing. The average peak value 14 over an interval under consideration of the pulse over which the function, of the peak value of at least one pulse of the pump signal, is increasing or decreasing is:
identical to the average peak value 14 over an interval of the pulse over which the function, of the peak value of at least one pulse of the pump signal, is increasing or decreasing and which chronologically succeeds the time interval under consideration,
identical to the average peak value 14 over an interval of the pulse over which the function, of the peak value of at least one pulse of the pump signal, is increasing or decreasing and which chronologically precedes the time interval under consideration.

The phase P of the signal 2 amplified and modulated by the SOA 3 is modulated so as to form a triangular signal. Moreover, the average value of the phase P over a time interval under consideration of the pulse, over which the phase P is increasing or decreasing, is
greater than the average value of the phase P over a time interval over which the phase P is increasing or decreasing and which chronologically succeeds the time interval under consideration,
smaller than the average value of the phase P over a time interval over which the phase P is increasing or decreasing and which chronologically precedes the time interval under consideration.

In particular, the peak value 14 of the pump signal 4 is successively increasing and decreasing over the course of one and the same pulse under consideration. This has the effect that the phase P of the pulse of the signal 2 amplified and modulated by the SOA 3 as a function of the pulse under consideration of the pump signal 4 has a phase value P which varies by modulo 2n several times over the course of the pulse of the signal 2 amplified and modulated by the SOA 3. Each variation by 2n of the phase over the course of the pulse of the signal 2 amplified and modulated by the SOA 3 preferably comprises an increase of the value of the phase at a moderate rate of the order of 1.10⁸ rad/s and a sharp decrease, designated a phase jump, at a rate as fast as possible, typically of the order of 1.10¹⁰ rad/s. According to the embodiment, the peak value 14 of the at least one pulse of the pump signal 4 varies in an increasing manner over at least one time interval of the at least one pulse of the pump signal 4 and varies in a decreasing manner over at least one time interval of the at least one pulse of the pump signal 4. In this case, preferably and by way of nonlimitative examples, the variation of the peak value 14 of the pump signal 4 over its part that is increasing or, as is the case according to the embodiment presented, decreasing over the course of one and the same pulse under consideration is greater, in absolute values, than 1.10⁸ amps per second (A/s) and more preferably than 1.10⁹ A/s or else than 1.10¹⁰ A/s.

In FIG. 5a, the phase P of the signal 2 amplified and modulated by the SOA 3 develops in a similar manner to the pump signal 4, contrary to FIG. 4a where the monotonic increase of the peak value of the pump signal 4 over the whole duration of the pulse implied a constant phase. Thus, the quick variation (rate of variation typically greater than 1.10⁸ A/s) of the peak value of the pump signal 4 has the effect of obtaining a non-zero variation of the phase P of the signal 2 amplified and modulated by the SOA 3. A moderate variation (rate of variation typically smaller than 1.10⁷ A/s) of the peak value of the pump signal 4 has the effect of obtaining a zero variation of the phase P of the signal 2 amplified and modulated by the SOA 3, i.e. a constant phase.

The spectrum of frequencies integrated over the duration of the pulse obtained by coherent detection on the basis of the amplified and modulated pulse signal 2, obtained by means of a peak value 14 of the pump signal 4 in the form of a triangular signal, and the local oscillator 61, is represented in FIGS. 5c and 5d. The power spectral density, in terms of relative amplitude, is illustrated there as a log scale for FIG. 5d and as a linear scale for FIG. 5c, on the y axis, as a function of the frequency, in MHz, on the x axis. With reference to FIGS. 5c and 5d, and compared with a square pump signal 4, the use of a peak value 14 of the triangular pump signal 4 makes it possible to obtain a frequency shift induced by the SOA of a controlled value, here of 19.1 MHZ. In practice, the frequency shift introduced by the SOA is a function of the gradient of the increase of the peak value 14 of the pump signal 4. With reference to FIGS. 5a and 5b, the frequency shift introduced by the SOA, as illustrated in FIG. 5d, is, or tends to become, proportional to the leading coefficient of the increasing parts of the triangular peak signal 14 when the variation of the peak value 14 of the pump signal 4 over the decreasing parts of the triangular peak signal 14 is greater than 1.10⁸ amps per second (A/s) and more preferably than 1.10⁹ A/s or else than 1.10¹⁰ A/s. Alternatively (not represented), the frequency shift introduced by the SOA is, or tends to become, proportional to the leading coefficient of the decreasing parts of the triangular peak signal 14 when the variation of the peak value 14 of the pump signal 4 over the increasing parts of the triangular peak signal 14 is greater than 1.10⁸ amps per second (A/s) and more preferably than 1.10⁹ A/s or else than 1.10¹⁰ A/s. Moreover, compared with FIG. 3d, a reduction of the broadening of the peak and an attenuation of the lobes at the base of the peak is noted, as for FIG. 4d.

According to the embodiment presented, and with reference to FIG. 6, the pulsed LiDAR 1 according to the invention comprises a master laser 5 capable of emitting a master laser beam 6, a pulse generator 10 capable of generating a pulsed pump signal 4, an SOA 3 arranged to amplify and modulate the master laser beam 6 as a function of the pump signal 4. The amplified and modulated master laser beam 2 forms a measurement laser beam 2. The pulsed LiDAR 1 also comprises a control unit 15 arranged to modulate a peak value 14 of at least one pulse of the square pulse signal (represented in FIG. 7a) emitted by the electrical generator 110. According to the embodiment, the pulsed LIDAR 1 comprises, moreover, a beam circulator or splitter 16, a telescope 17, an optical sensor 18 and optical fibres 19 connecting the components and arranged to convey the signals from one element of the LiDAR 1 to another. The measurement laser beam 2, when it reaches a target, for example a particle, is partly reflected and/or backscattered towards the LiDAR 1. This reflected and/or backscattered part is called return laser beam 24, returns through the telescope 17, enters the circulator 16 through the second input/output and exits through a third input/output in order to be directed towards the optical sensor 18. The reference signs described in FIG. 1 remain unchanged.

With reference to FIG. 7a, the use of a square pump signal 4 as described in the state of the art is illustrated. FIG. 7b represents the development of the power of the signal 2 amplified and modulated by the SOA 3 during the pulse. FIG. 7c represents the development of the frequency f of the signal 2 amplified and modulated by the SOA 3 during the pulse. A variation of the frequency of the amplified and modulated signal 2 around the reference frequency f_{ref} of the local oscillator is observed. The frequency of the amplified and modulated signal 2 drifts from a frequency f₂ greater than the reference frequency f_{ref} down to a frequency f₁ smaller than the reference frequency f_{ref}. The spectrum of frequencies integrated over the duration of the pulse obtained by coherent detection on the basis of the amplified and modulated pulse signal 2, obtained by means of a square pump signal 4, and the local oscillator 61, is represented in FIG. 7d. FIG. 7d illustrates the power spectral density, in terms of relative amplitude, on the y axis, as a function of the frequency, in MHZ, on the x axis. The ideal peak which should theoretically be obtained on the basis of a square signal and the actual peak which is actually obtained using a square pump signal 4 is illustrated there. The broadening of the peak and the appearance of a lobe at the base of the peak induced by the drift of the frequency of the amplified and modulated signal 2 can be observed.

Embodiments of the control unit 15 according to the invention are illustrated in FIG. 8. The control unit 15 comprises one or more switches 22 arranged to vary the pump signal 4 by switching, modulating and controlling the square pulse signal (represented in FIG. 7a) emitted by the electrical generator 110. The pulse generator 10 comprises, moreover, a control unit 15, a power supply 101, an energy storage device 20, for example a capacitor 20, and a control circuit 22 of the switch or switches 22. The control unit 15 is arranged to modulate, as defined previously, the square pulse signal (represented in FIG. 7a) emitted by the electrical generator 110 so as to generate a variation of the peak value 14 of the pulses of the pump signal 4.

The control unit 15 makes it possible to obtain pulses of the pump signal 4 of several amps, or even tens of amps, which are brief, of a few tens of nanoseconds, and with quick rising 12 and falling 13 edges, typically shorter than 10 ns.

With reference to FIGS. 8a and 8b, the switch or switches 22 are nMOS. With reference to FIGS. 8c and 8d, the switch or switches 22 are pMOS.

With reference to FIGS. 8b and 8d, the control unit 15 comprises a switch 221, called primary switch 221, and a switch 222, called secondary switch 222. The secondary switch 222 is arranged to switch and modulate the electrical signal more quickly than the primary switch 221. The secondary switch 222 makes it possible to ensure a very good optical extinction, typically greater than 70 dB, and to improve the fall time 12 of the SOA 3. The secondary switch 222 has the function of more quickly dissipating the loads of the SOA 3 when SOA 3 is in the process of amplifying the master laser beam 6.

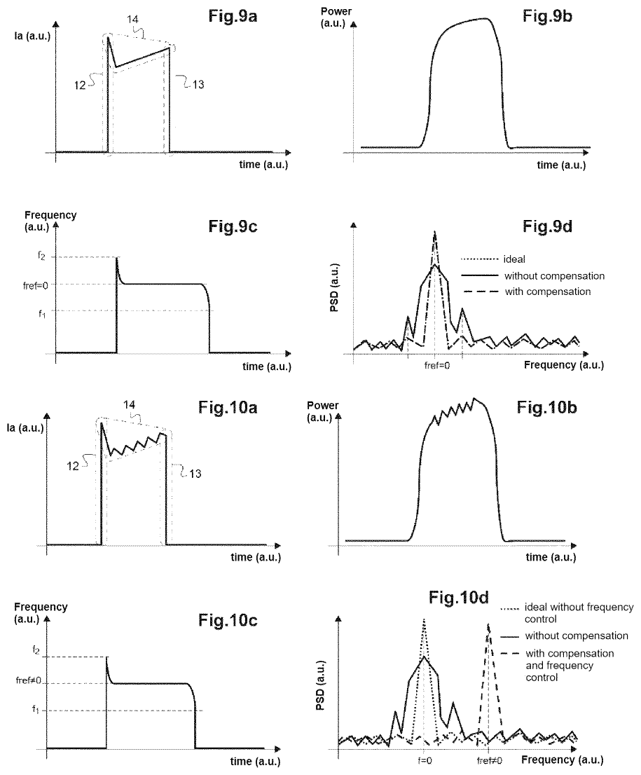

With reference to FIG. 9, the use of the control unit 15 to modulate the peak value 14 of the pump signal 4 by linearly and monotonically increasing the peak value 14 of the square pulse signal (represented in FIG. 7a) emitted by the electrical generator 110 is illustrated.

FIG. 9a illustrates a pulse of the pump signal 4 varying linearly in an increasing and monotonic manner over the course of the pulse. FIG. 9b represents the development of the frequency f of the signal 2 amplified and modulated by the SOA 3 during the pulse. FIG. 9c represents the development of the power of the signal 2 amplified and modulated by the SOA 3 during the pulse. The spectra of frequencies integrated over the duration of the pulse obtained by coherent detection from amplified and modulated pulse signals 2, obtained by different pump signals 4, and the local oscillator 61, are represented in FIG. 9d. FIG. 9d illustrates the power spectral density, in terms of relative amplitude, on the y axis, as a function of the frequency, in MHZ, on the x axis. The ideal peak sought for the requirements of the LiDAR, the peak without compensation which is obtained on the basis of a square pump signal 4 and the peak with compensation obtained on the basis of the pump signal 4 as described in FIG. 9a are represented there. It is observed that the peak without compensation obtained on the basis of the square pump signal 4 is broad and has lobes at its base. This is induced by the drift of the frequency of the amplified and modulated signal 2. The peak with compensation obtained on the basis of the pump signal 4 as described in FIG. 9a is centred on the reference frequency of the master laser beam 6 with Δf=0 where Δf is equal to the difference between the frequency of the signal 2 amplified and modulated by the SOA 3 and the frequency (f_{ref}) of the master laser beam (or local oscillator) 61. Moreover, compared with the peak without compensation, a reduction of the broadening of the peak and an attenuation of the lobes at the base of the peak is noted, as for FIG. 4d.

With reference to FIG. 10, the use of the control unit 15 to vary the peak value 14 of the pump signal 4 by modulating the square pulse signal (represented in FIG. 7a) emitted by the electrical generator 110 is illustrated:
by successively increasing and decreasing the peak value 14 of the pump signal 4, and
increasing, nonlinearly and nonmonotonically, the peak value 14 of the pump signal 4 over the duration of the pulse. More precisely, the control unit 15 is arranged to vary the peak value 14 of the pulses of the pump signal 4 by modulating the square pulse signal (represented in FIG. 7a) emitted by the electrical generator 110 such that an average peak value 14 over a time interval of the pulse over which the function is increasing, or respectively decreasing, is smaller than or greater than an average peak value 14 over another time interval of the pulse over which the function is increasing, or respectively decreasing. Still more precisely, the average peak value 14 over an interval under consideration of the pulse over which the function is increasing or decreasing is:
smaller than an average peak value 14 over an interval of the pulse over which the function is increasing or decreasing and which chronologically succeeds the time interval under consideration,
greater than an average peak value 14 over an interval of the pulse over which the function is increasing or decreasing and which chronologically precedes the time interval under consideration.

In practice, the pulse generator 10 is arranged to generate a triangular pump signal 4. The pump signal 4 comprises five triangles over the course of a pulse. Moreover, the peak value 14 at the end of the rise 12 of a triangle under consideration is greater than the peak value 14 at the end of the rise 12 of a triangle which, chronologically, precedes the triangle under consideration. Moreover, the peak value 14 at the end of the fall 13 of a triangle under consideration is smaller than the peak value 14 at the end of the fall 13 of a triangle which, chronologically, precedes the triangle under consideration. In other words, the pulse generator 10 is arranged to increase or decrease, over the course of a pulse and nonlinearly and nonmonotonically, the average peak value 14 of the pump signal 4.

FIG. 10a illustrates a pulse of a triangular pump signal 4 increasing nonmonotonically. FIG. 10b represents the development of the frequency of the signal 2 amplified and modulated by the SOA 3 during the pulse. FIG. 10c represents the development of the power of the signal 2 amplified and modulated by the SOA 3 during the pulse. The spectra of frequencies integrated over the duration of the pulse obtained by coherent detection on the basis of amplified and modulated pulse signals 2, obtained by different pump signals 4, and the local oscillator 61, are represented in FIG. 10d. FIG. 10d illustrates the power spectral density, in terms of relative amplitude,

on the y axis, as a function of the frequency, in MHZ, on the x axis. The ideal peak sought for a LIDAR application, the peak without compensation actually obtained on the basis of a square pump signal 4 and the peak with compensation and frequency control obtained on the basis of the triangular pump signal 4 increasing nonmonotonically illustrated in FIG. 10a are represented there. It is observed that the peak without compensation obtained on the basis of the square pump signal 4 is broad and has lobes at its base. This is induced by the drift of the frequency of the amplified and modulated signal 2. The peak with compensation and frequency control obtained on the basis of the triangular pump signal 4 increasing nonmonotonically has a frequency shift of the peak with a controlled value. The shift is a function of the gradient of the average increase of the peak value 14 of the pump signal 4. Moreover, compared with the peak without compensation actually obtained on the basis of a square pump signal 4, a reduction of the broadening of the peak and an attenuation of the lobes at the base of the peak is noted, as for FIG. 4d.

Of course, the invention is not limited to the examples that have just been described, and numerous modifications may be made to these examples without exceeding the scope of the invention.

Thus, in the variants that can be combined together of the embodiments described above:
the peak value 14 of the at least one pulse of the pump signal 4 comprises an average peak value 14 over a time interval of the at least one pulse of the pump signal 4, preferably over a time interval of the at least one pulse of the pump signal over which the peak value 14 is increasing or decreasing, which is smaller than or greater than an average peak value 14 over another time interval of the at least one pulse of the pump signal 4, preferably over a time interval of the at least one pulse of the pump signal 4 over which the peak value 14 is increasing or decreasing, and/or
a frequency of at least one pulse of the signal 2 amplified and modulated by the SOA 3 is shifted, adjusted or modulated as a function of a gradient of the peak value 14 of the at least one pulse of the pump signal 4 over the at least one time interval of the at least one pulse of the pump signal 4 over which the peak value 14 is increasing and/or as a function of a gradient of the peak value 14 of the at least one pulse of the pump signal 4 over the at least one time interval of the at least one pulse of the pump signal 4 over which the peak value 14 is decreasing,
the peak value 14 of the at least one pulse of the pump signal 4:
varies monotonically over at least one time interval of the at least one pulse of the pump signal 4, and/or
is increasing over at least one time interval of the at least one pulse of the pump signal 4 and/or is decreasing over at least one time interval of the at least one pulse of the pump signal 4, and/or
the method comprises the determination of the modulation of the peak value 14, to be applied, on the basis of data:
of the phase of the signal 2 amplified and modulated by the SOA 3, and
data of the peak value 14 of the at least one pulse of the pump signal 4 as a function of which the master laser beam 2 is amplified and modulated, and/or
the phase of a pulse of the signal 2 amplified and modulated by the SOA 3 is modulated in order that an average value of the phase P over a time interval under consideration of the pulse over which the phase is increasing, or respectively decreasing, is:
identical to the average peak value over an interval of the pulse which chronologically succeeds the time interval under consideration,
identical to the average peak value over an interval of the pulse which chronologically precedes the time interval under consideration.

In addition, the various characteristics, forms, variants and embodiments of the invention can be combined together in various combinations, to the extent that they are not incompatible or mutually exclusive.

1. A pulsed LiDAR comprising:
a master laser capable of emitting a master laser beam;
a pulse generator arranged to generate a pump signal comprising at least one pulse, a peak value of which varies over the course of said at least one pulse of said pump signal; and
a semiconductor optical amplifier (SOA) arranged to amplify and modulate the master laser beam as a function of the pump signal, the amplified and modulated master laser beam forming a measurement laser beam.

2. The LiDAR according to claim 1, in which the pulse generator comprises:
an electrical generator arranged to produce a pulse signal; and
a control unit arranged to vary the peak value of the at least one pulse of the pump signal by modulating at least one pulse of the pulse signal produced by the electrical generator.

3. The LiDAR according to claim 1, in which the peak value of the at least one pulse of the pump signal varies monotonically over at least one time interval of the at least one pulse of the pump signal.

4. The LiDAR according to claim 1, of which the peak value of the at least one pulse of the pump signal varies monotonically over the whole duration of the at least one pulse of the pump signal.

5. The LiDAR according to claim 1, in which the peak value of the at least one pulse of the pump signal varies in an increasing manner over at least one time interval of the at least one pulse of the pump signal and/or varies in a decreasing manner over at least one time interval of the at least one pulse of the pump signal.

6. The LiDAR according to claim 1, in which the peak value of the at least one pulse of the pump signal comprises an average peak value over a time interval of the at least one pulse of the pump signal which is equal to an average peak value over another time interval of the at least one pulse of the pump signal.

7. The LiDAR according to claim 1, in which the peak value of the at least one pulse of the pump signal comprises an average peak value over a time interval of the at least one pulse of the pump signal which is smaller than or greater than an average peak value over another time interval of the at least one pulse of the pump signal.

8. The LiDAR according to claim 1, in which the control unit comprises at least one switch arranged to control and/or modulate the pulse signal.

9. The LiDAR according to claim 1, comprising a fibre optic amplifier arranged to amplify the amplified and modulated master laser beam.

10. A method of amplifying a master laser beam of a pulsed LiDAR, comprising the steps consisting of:
generating a pump signal comprising at least one pulse, a peak value of which varies over the course of said at least one pulse of said pump signal; and
amplifying and modulating the master laser beam by means of a semiconductor optical amplifier (SOA) of the pulsed LiDAR as a function of the generated pump signal, the amplified and modulated master laser beam forming a measurement laser beam.

11. The method according to claim 10, comprising the step consisting of varying the peak value of the at least one pulse of the pump signal by modulating at least one pulse of a pulse signal.

12. The method according to claim 10, in which the peak value of the at least one pulse of the pump signal:
varies monotonically over at least one time interval of the at least one pulse of the pump signal, and/or
is increasing over at least one time interval of the at least one pulse of the pump signal and/or is decreasing over at least one time interval of the at least one pulse of the pump signal.

13. The method according to claim 12, in which a frequency of at least one pulse of the signal amplified and modulated by the SOA is shifted as a function of a gradient of the peak value of the at least one pulse of the pump signal over the at least one time interval of the at least one pulse of the pump signal over which the peak value is increasing, and/or as a function of a gradient of the peak value of the at least one pulse of the pump signal over the at least one time interval of the at least one pulse of the pump signal over which the peak value is decreasing.

14. The method according to claim 10, in which the peak value of the at least one pulse of the pump signal comprises an average peak value over at least one time interval of the at least one pulse of the pump signal which is equal to an average peak value over at least one other time interval of the at least one pulse of the pump signal.

15. The method according to claim 10, in which the peak value of the at least one pulse of the pump signal comprises an average peak value over at least one time interval of the at least one pulse of the pump signal which is smaller than or greater than an average peak value over at least one other time interval of the at least one pulse of the pump signal.

16. The method according to claim 10, comprising a measurement of data relating to a phase of the signal amplified and modulated by the SOA.

17. The method according to claim 16, comprising a determination of the modulation of the at least one pulse of the pulse signal and/or the variation of the peak signal of the at least one pulse of the pump signal on the basis of data:
relating to the phase of the signal amplified and modulated by the SOA, and
of the peak value of the at least one pulse of the pump signal as a function of which the master laser beam is amplified and modulated.
